(19) United States
(12) Patent Application Publication
(10) Pub. No.: US 2005/0057006 A1
(43) Pub. Date: Mar. 17, 2005

(54) Door sealing strip and cooking device

(75) Inventors: Christian Gassner, Chieming (DE); Robert Hasslberger, Ruhpolding (DE); Michael Wagner, Grabenstatt (DE)

Correspondence Address: John T. Winburn;BSH Home Appliances Corporation, 100 Bosch Blvd, New Bern, NC, 28562, US

(73) Assignee: BSH Bosch und Siemens Hausgeräte GmbH, Munich (DE)

(21) Appl. No.: 10/848,194

(22) Filed: May 18, 2004

(30) Foreign Application Priority Data
Nov. 5, 2002 (WO) PCT/EP02/12335
Nov. 5, 2002 (WO) 03/044435 A1
Nov. 19, 2001 (DE) DE 101 56 778.2

(51) Int. Cl. F16J 15/08

(52) U.S. Cl. 277/650

(57) ABSTRACT

A door sealing strip for a cooking device containing a cooking compartment having an opening therein, a cooking compartment flange surrounding the cooking compartment opening and having a high temperature area, and a door for closing the cooking compartment opening. The door sealing strip containing a core strip made from a highly heat-resistant fibre material as a sealing element and a sheath made of a plastic material formed from a heat-resistant fibre material as a sealing element. The core strip having contact with the flange high temperature area in the sheath gap.

The invention relates to a door sealing strip of a cooking device in accordance with the preamble to claim 1, and a cooking device in accordance with the preamble to claim 8.

A cooking device can be, for example, a baking oven, a cooker, a grill, or a microwave device, and in particular such a cooking device with pyrolytic self-cleaning function.

A sealing strip of the type of the preamble to claim 1 is known from DE-G 91 06 860.6, which shows a sealing sheath made of glass silk with a wire core running axially in the interior of the sealing sheath.

In order to save energy, avoid burning of persons, and to avoid overheating of operating elements on the front of the device, the oven flange can be thermally detached from the oven by means of slots or other means. In order on the one hand for these slots not to be visible to the customer, and, on the other, for them to be sealed against the oven, they are located behind the oven seal, and in special designs in the base of a circumferential groove in the oven flange, in which the oven seal is arranged. As a result of the thermal detachment, a sharp temperature rise now occurs at the detachment point. On the oven side of the slots the temperatures are very high, in particular during pyrolysis operation, e.g. greater than 350° C. This temperature is too high for a silicone seal in contact with this surface, with the result that, according to the prior art, only a glass silk seal can be used, with its known disadvantages (poor sealing effect, absorption of grease, etc.). The flange part located outside the slots is, by contrast, perceptibly cooler, e.g. less than 280° C.

Known materials with high heat resistance, such as materials which can be used at temperatures above 350° C., such as glass for example, are frequently hard and brittle, and are only suitable for use as sealing material in the form of a plurality of fibres. However, even these fibre seals have a poor sealing effect, which becomes worse as the service life increases. In addition to this, they easily become dirty, absorb grease, for example, and are difficult to clean. By contrast, heat-resistant plastics, for example polymers, such as silicone, exhibit a smooth and closed surface and are more elastic, with the result that they have a better sealing effect than fibre material, look more attractive, and are easier to clean. They are, however, less heat resistant than fibre material, and than glass silk in particular.

The intention is that the invention should resolve the problem of providing a door seal for a cooking device which is both suitable for high temperatures, such as occur during pyrolysis operation, for example, as well as exhibiting a permanently good sealing effect.

This problem is resolved according to the invention by the characterisation features of claim 1.

The invention is characterised, according to claim 1, by a core strip made of a highly heat-resistant fibre material as a sealing element, and by a material made of a plastic which is likewise heat-resistant but less so, as a sealing element, which partially surrounds the core strip with the exception of a gap which exposes the core strip, in which the core strip can be laid with sealing effect on a hotter area of the cooking device than the sheath, which is laid with sealing effect on a less hot area of the cooking device.

By contrast with the pure fibre seal, in particular a pure glass silk seal, the advantages of the invention lie in particular in the easier cleaning capacity (smooth surface), the better visual impression (fibre material, especially glass silk, rapidly becomes spotty), and in the better technical function (better sealing effect, in particular because the seal does not become so saturated with grease and hardened).

Other features of the invention are contained in the sub-claims.

The core strip can be formed from any suitable temperature-resistant fibre material which accords with the requirements. The core strip can be formed, for example, by a glass silk seal or a glass braided hose, with the advantage that glass is highly heat-resistant and is an economical material.

The sheath consists for preference of silicone. The advantage is that silicone is a known heat-resistant sealing material with very good sealing properties. The sheath can, however, be formed from any other desired plastic which is sufficiently heat-resistant to meet the requirements.

The core strip is for preference coated with the material of the sheath, for example by spraying, immersion, or other known coating techniques. The advantage of this is that a coating is sparing of resources and economical, since only small quantities of the sheath material are required for the partial surrounding of the core strip with the sheath. In addition to this, a coating adheres to the fibre material without slippage and gaps in the fibre are closed.

The sheath surrounds the core strip for preference over a circumferential angle of more than 180°. As a result, the contamination of the fibre material, for example by grease, is largely avoided, a very good sealing effect is achieved, and the fibre material is largely not visible. The visual effect is determined by the plastic material.

The object of the invention is further resolved by the features of claim 8.

According to this, provision is made for the minimum of one door sealing strip to be formed in accordance with at least one of claims 1 to 7, that a high-temperature cooking device area is allocated to the core strip in the sheath gap, and that an area of the cooking device which is relatively low-temperature is allocated to the sheath.

This results in the advantages for the cooking device which have been presented heretofore with regard to claims 1 to 7. According to the invention, only the core strip made of fibre material comes in contact with the high temperatures of the cooking compartment. The sheath, made for example of silicone, only comes in contact with sealing points which have a temperature of less than 300° C., for which silicone is still suitable.

Provision can be made, for example, for a single closed door sealing strip which surrounds the cooking compartment in a ring shape. In addition, two or more door sealing strips can be provided for, which surround the cooking compartment opening circumferentially in sections. Hereinafter reference is made in each case to a door sealing strip which can be the sole door sealing strip or one of the two or more door sealing strips.

According to one embodiment, provision is made for the cooking compartment flange to be provided with at least one heat detachment slot, that the core strip is arranged in the sheath gap in contact with the heat detachment slot, that the core strip is arranged in the sheath gap in contact with the hot side of the cooking compartment flange, but that the sheath is located at a distance from this hot side. The advantages are that the heat detachment slot is sealed against the cooking compartment, as well as a reduction of the temperature in an outer area on a side of the door sealing strip which is turned away from the cooking compartment, and, as a result, there is also a reduction of the temperature of the sheath at the cooking compartment door.

The sheath can also be arranged so as to be in contact with a cold side of the cooking compartment flange, thermally detached from the hot side by the minimum of one heat detachment slot. The advantages are better sealing effect of the door sealing strip, because the sheath made of the heat-resistant plastic forms an additional thermal barrier against the cooking compartment flange and achieves a better sealing effect than the core strip made of fibre material.

The sheath can be arranged so as to be in contact with the cooking compartment door. The advantage of this is a better appearance and a better sealing effect of the door sealing strip, because the sheath achieves a better sealing effect against the door than fibre material.

The door sealing strip can be secured to the cooking compartment flange, whereby the cooking compartment door in the closed state is in contact with the sheath of the door sealing strip so as to form a seal, and in the open state is located at a distance from the door sealing strip. The advantage is that the inner side of the door, opposite the cooking compartment, which is subjected to more severe dirt contamination, in particular in its open state, than the cooking compartment flange extending vertically, can be formed as a smooth surface, which is easier to clean than a door sealing strip secured to it. As an alternative, however, there is the possibility for the door sealing strip to be secured to the cooking compartment door instead of to the cooking compartment flange.

The silicone sheath can extend, for example, over a circumferential surrounding angle of approximately 200°. It is also conceivable, however, for the silicone sheath to be drawn into the heat detachment slot (circumferential surrounding angle of approximately 270°, for example).

The invention is described hereinafter with reference to the drawings, on the basis of preferred embodiments as examples.

The drawings show:

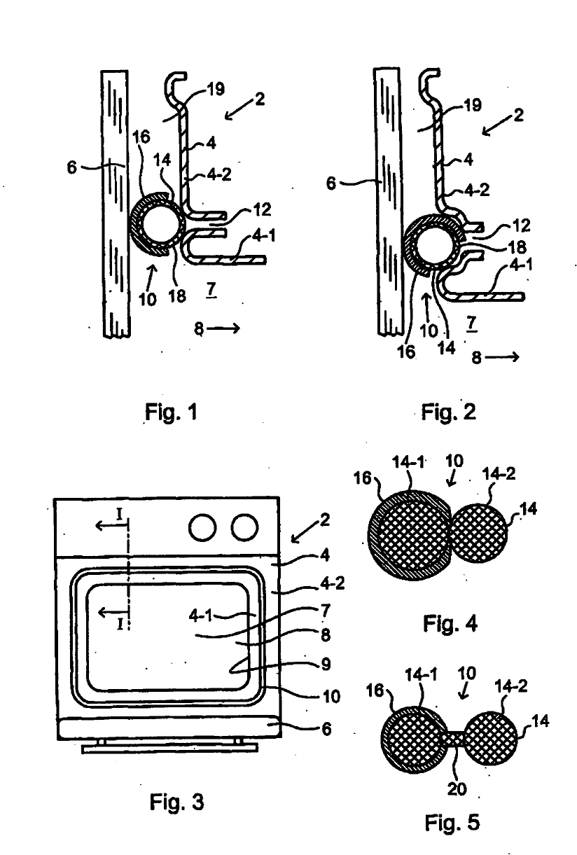

FIG. 1 partial cross-sectional view of a cooking device according to the invention along the plane I-I in FIG. 3;

FIG. 2 partial cross-sectional view of a further embodiment of a cooking device according to the invention along the plane I-I in FIG. 3;

FIG. 3 frontal view of the cooking device with the cooking compartment door pivoted downwards;

FIG. 4 cross-section through an embodiment of a door sealing strip according to the invention;

FIG. 5 cross-section through a further embodiment of a door sealing strip according to the invention.

A cooking device 2 according to the invention exhibits a cooking compartment flange 4 and a cooking compartment door 6, with which a cooking compartment opening 8 of a cooking compartment 7 can be closed, which is formed in a cooking compartment muffle 8 (oven). The cooking device 2 further contains a door sealing strip 10 between the cooking compartment flange 4 and the cooking compartment door 8. The door sealing strip 10 can be secured, for example, to the cooking compartment flange 4, as shown in FIG. 3, or secured to the cooking compartment door 6. The cooking compartment flange 4 is a part of the cooking device, which surrounds the cooking compartment opening 8 and is located opposite the cooking compartment door 6 in the door closed position.

The following description relates to a cooking device 2 with a closed cooking compartment door 6 (closed position). It is understood that, with the cooking compartment door 6 open (open position), the door sealing strip 10 is only in contact with the cooking compartment door 6 or the cooking compartment flange 4, depending on whether the door sealing strip 10 is secured to the cooking compartment door 6 or to the cooking compartment flange 4.

The cooking compartment flange 4 contains at least one heat detachment slot 12 extending around the cooking compartment opening 8, which thermally detaches a hotter high-temperature part 4-1 of the cooking compartment flange 4, closer to the cooking compartment opening 8, from a less hot low-temperature part 4-2 of the cooking compartment flange 4 located opposite. During the operation of the cooking device 2, the high-temperature part 4-1 is subjected to higher temperatures (such as >350° C.) than the low-temperature part 4-2 (such as <260° C.). The heat detachment slot 12 can consist of a slot extending continuously around the entire cooking compartment opening 8, or of a plurality of openings or individual slots, which are arranged one after another around the cooking compartment opening 8.

The door sealing strip 10 contains a core strip 14 made of a highly heat-resistant fibre material, e.g. of fibre braided hose, for example of glass fibre, and of glass silk in particular. The core strip 14 is partially surrounded by a sheath 16 made of heat-resistant plastic, in particular of silicone, whereby a gap 18 extending in the longitudinal direction of the strip remains in the sheath 16. The core strip 14 is, for example, partially coated with the heat-resistant plastic. The sheath 16 allows for simple cleaning and a good sealing effect of the door sealing strip 10.

The core strip 14 is arranged in the gap 18 in contact with the high-temperature part 4-1 of the cooking compartment flange 4, while by contrast the sheath 16, at an interval from the high-temperature part 4-1, is distanced from this, and is arranged in contact with the cooking compartment door 6, in order to seal the cooking compartment against the cooking compartment door 6. The core strip 14 can be arranged so as to be in contact also with the low-temperature part 4-2 as well as with the high-temperature part 4-1. In this case, two sealing parts are produced at the cooking compartment flange, and therefore an improved sealing effect.

The sheath 16 can be arranged at a distance from the low-temperature part 4-2, as shown in FIG. 1, or the sheath 16 can be arranged so as to be in contact with the low-temperature part 4-2, and, for example, extend also into the minimum of one heat detachment slot 12, as shown in FIG. 2. In particular when the sheath 16 is additionally in contact with the cooking compartment door 6 as well as with the low-temperature part 4-2, an especially good sealing effect is derived, since in this case the sheath 16 bridges a door gap 19 between the cooking compartment door 6 and the cooking compartment flange 4 without leaving a gap.

The core strip 14 can be take the form of a hose (FIG. 1 and FIG. 2) or a full strip (FIG. 4 and FIG. 5). In addition, the core strip 14 can exhibit a circular cross-section (FIG. 1, FIG. 2) or a cross-section which deviates from the circular shape. In particular, the core strip 14 can exhibit two circular core part strips 14-1, 14-2, which are, for example, connected directly adjacent to one another (FIG. 4). The two core part strips 14-1, 14-2 can also be arranged at a distance from one another, and be connected to one another by connecting means 20, in particular by a dart (FIG. 5). The connection between the core part strips 14-1, 14-2 or with the connecting means 20 can be provided by any suitable means, in particular by seaming, welding, and/or by the sheath 16.

1-12. (canceled)

13. A door sealing strip for a cooking device, comprising:
a cooking compartment having an opening therein;
a cooking compartment flange substantially surrounding said cooking compartment opening;
a cooking compartment door for closing said cooking compartment opening;
the door sealing strip including a core strip formed from a highly heat-resistant fibre material as a sealing element; and
a sheath made of a plastic material formed from a heat-resistant material as a sealing element, having a heat-resistance less than said heat-resistance of said core strip fibre material, said sheath partially surrounding said core strip and forming a gap exposing a portion of said core strip.

14. The door sealing strip according to claim 13, including said core strip formed from glass silk to form said sealing element.

15. The door sealing strip according to claim 13, including said core strip coated with said sheath material.

16. The door sealing strip according to claim 13, including said sheath formed from silicone to form said sealing element.

17. The door sealing strip according to claim 13, including said sheath partially surrounding said core strip by greater than about one hundred and eighty degrees (180°).

18. The door sealing strip according to claim 13, including said core strip formed as a double strip with a first core strip portion and a second core strip portion connected to one another.

19. The door sealing strip according to claim 13, including said core strip formed as a double strip with a first core strip portion and a second core strip portion connected to one another spaced at a distance from one another by connecting means.

20. A cooking device including pyrolytic self-cleaning, comprising:
a cooking compartment having an opening therein;
a cooking compartment flange substantially surrounding said cooking compartment opening and having a high temperature area;
a cooking compartment door for closing said cooking compartment opening and having a temperature area lower in temperature than said high temperature area;
a door sealing strip including a core strip formed from a highly heat-resistant fibre material as a sealing element;
a sheath made of a plastic material formed from a heat-resistant material as a sealing element, having a heat-resistance less than said heat-resistance of said core strip fibre material, said sheath partially surrounding said core strip and forming a sheath gap exposing a portion of said core strip; and
said core strip in contact with said flange high temperature area in said sheath gap.

21. The cooking device according to claim 20, including said cooking compartment flange includes at least one heat detachment slot, including a hot flange portion close to said cooking compartment and said core strip contacts said hot flange portion with said sheath arranged at a distance from said hot flange portion.

22. The cooking device according to claim 21, including said cooking compartment flange including a second cooler flange portion removed from said cooking compartment and said sheath contacts said cooler flange portion.

23. The cooking device according to claim 21, including said sheath contacts said door cooking compartment flange.

24. The cooking device according to claim 21, including said door sealing strip secured to said cooking compartment flange and said cooking compartment door contacts said sheath when said door is closed and said door is distanced from said door sealing strip when said door is open.

25. The cooking device according to claim 21, including said core strip formed from glass silk to form said sealing element.

26. The cooking device according to claim 21, including said sheath formed from silicone to form said sealing element.

27. The cooking device according to claim 21, including said core strip coated with said sheath material.

28. The cooking device according to claim 21, including said sheath partially surrounding said core strip by greater than about one hundred and eighty degrees (180°).

29. The cooking device according to claim 21, including said core strip formed as a double strip with a first core strip portion and a second core strip portion connected to one another.

30. The cooking device according to claim 21, including said core strip formed as a double strip with a first core strip portion and a second core strip portion connected to one another spaced at a distance from one another by connecting means.
